(19) United States
(12) Patent Application Publication
(10) Pub. No.: US 2025/0171361 A1
(43) Pub. Date: May 29, 2025

(54) MOISTURE-RESISTANT GYPSUM BOARDS AND METHODS OF MAKING THEM

(71) Applicant: CERTAINTEED GYPSUM, INC., Malvern, PA (US)

(72) Inventors: Dahlia AMATO, Malvern, PA (US); Patrick R. McGINLEY, Phoenixville, PA (US); Cassandra TUBBS, Boylston, MA (US); Serge ADJOUA, Mason, OH (US); Remi LESPIAT, Devon, PA (US)

(21) Appl. No.: 18/955,351

(22) Filed: Nov. 21, 2024

Related U.S. Application Data
(60) Provisional application No. 63/603,821, filed on Nov. 29, 2023.

(51) Int. Cl. C04B 28/14; C04B 11/00; C04B 14/36; C04B 14/42; C04B 24/38; C04B 103/30; C04B 111/00

(52) U.S. Cl. CPC C04B 28/144; C04B 11/007; C04B 14/361; C04B 14/42; C04B 24/383; C04B 28/141; C04B 28/145; C04B 2103/34; C04B 2111/0062

(57) ABSTRACT

A gypsum-based construction material can include gypsum core including a stucco component, a siloxane component at a content of not greater than about 2.0 wt. % relative to a content of the stucco component, and a calcium hydroxide catalyst at a content of at least about 0.01 wt. % and not greater than about 0.1 wt. % relative to the content of the stucco component. The gypsum-based construction material can have a pH of at least about 7.5 and not greater than about 10.

### CROSS-REFERENCE TO RELATED APPLICATION(S)

This application claims priority under 35 U.S.C. § 119(e) to U.S. Provisional Patent Application No. 63/603,821, entitled “MOISTURE-RESISTANT GYPSUM BOARDS AND METHODS OF MAKING THEM,” by Dahlia AMATO et al., filed Nov. 29, 2023, which is assigned to the current assignee hereof and is incorporated herein by reference in its entirety.

### FIELD OF THE DISCLOSURE

The present disclosure relates to moisture-resistant gypsum boards and methods of making the same.

### BACKGROUND

Gypsum building products (e.g., known variously as wallboard, ceiling board, plasterboard and “drywall”) are panels made of a gypsum core sandwiched between two layers of liner, often paper, on the outside surfaces of the gypsum core. They are widely used as construction materials due to their ease of fabrication, high mechanical strength, low thermal conductivity, resistance to spread of fire, and soundproofing properties. The quality of a gypsum board is strongly dependent on its gypsum core, which is fabricated by the hydration of stucco slurry (mainly containing calcium sulfate hemihydrate) into a set body of calcium sulfate dihydrate. To control the properties of gypsum boards, additives are often added to the stucco slurry during the board making process. For example, foaming agents, inorganic compounds, and other additives may be included in the slurry to modulate the density, strength, and/or fire resistance properties of the board.

To provide moisture-resistant gypsum boards, it has been common to incorporate small amounts of polymethylhydrosiloxane (PMHS) to improve the moisture resistance properties of the board. The PMHS undergoes hydrolysis, to form silanol, which then crosslinks when heated forming cured silicone. The presence of cured silicone in the boards improves water resistance. By including PMHS, the gypsum boards have reduced board shrinkage at elevated temperatures, which is indicative of improved structural integrity. However, PMHS has become a cost prohibitive additive due to a worldwide shortage. As such, there is a need in the art to find methods and compositions that allow for improved moisture resistance while reducing the amount of PMHS.

### SUMMARY

According to one embodiment, a gypsum-based slurry composition is disclosed. The gypsum-based slurry composition can include a precursor stucco component, a precursor siloxane component and a precursor calcium hydroxide catalyst. The precursor siloxane component can be present at a content of not greater than about 2.0 wt. % relative to a content of the precursor stucco component. The precursor calcium hydroxide catalyst can be present at a content of at least about 0.01 wt. % and not greater than about 0.1 wt. % relative to a content of the precursor stucco component. The pH of the gypsum-based slurry composition can be at least about 7.5 and not greater than about 10.

According to a further embodiment, a gypsum-based construction material is disclosed. The gypsum-based construction material can include a gypsum core. The gypsum core can include a stucco component, a siloxane component and a calcium hydroxide catalyst. The precursor siloxane component can be present at a content of not greater than about 2.0 wt. % relative to a content of the precursor stucco component. The precursor calcium hydroxide catalyst can be present at a content of at least about 0.01 wt. % and not greater than about 0.1 wt. % relative to a content of the precursor stucco component. The pH of the gypsum core can be at least about 7.5 and not greater than about 10.

According to a further embodiment, a method of forming a gypsum-based construction material is disclosed. The method can include providing the aforementioned gypsum-based slurry composition, depositing the slurry composition to form a gypsum core of the gypsum-based construction material preform, and firing the gypsum core of the gypsum-based construction material.

### BRIEF DESCRIPTION OF THE DRAWINGS

The present disclosure may be better understood, and its numerous features and advantages made apparent to those skilled in the art by referencing the accompanying drawings.

FIG. 1 is an illustration of a moisture-resistant board as described herein.

### DETAILED DESCRIPTION

The following description in combination with the FIGURES is provided to assist in understanding the teachings disclosed herein. The following discussion will focus on specific implementations and embodiments of the teachings. This focus is provided to assist in describing the teachings and should not be interpreted as a limitation on the scope or applicability of the teachings.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus.

As used herein, and unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” are employed to describe elements and components described herein. This is done merely for convenience and to give a general sense of the scope of the invention. This description should be read to include one or at least one and the singular also includes the plural unless it is obvious that it is meant otherwise.

The use of the word “about,” “approximately,” or “substantially” is intended to mean that a value of a parameter is close to a stated value or position. However, minor differences may prevent the values or positions from being exactly as stated. Thus, differences of up to ten percent (10%) for the value are reasonable differences from the ideal goal of exactly as described.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the construction products arts.

Various embodiments of the present disclosure will now be described, by way of example only, with reference to the accompanying drawings.

The present inventors have developed a method of producing a moisture-resistant board that requires significantly less polymethylhydrosiloxane (PMHS) while still maintaining moisture resistance properties.

As described above, PMHS is often used to provide moisture resistance properties to gypsum boards. However, the use of PMHS in gypsum boards is becoming more expensive due to the short supply of the silicone oil. As such, there is a need in the art to find ways to reduce PMHS usage that provides the same moisture resistance properties to gypsum boards.

The present disclosure is concerned with moisture-resistant gypsum boards comprising a gypsum core and methods for making them. As such, in one embodiment, the present disclosure describes a method for producing a moisture-resistant gypsum board comprising a gypsum core. The method may comprise providing a gypsum-based slurry composition comprising a precursor stucco component, a precursor siloxane component at a content of not greater than about 2.0 wt. % relative to a content of the precursor stucco component, and a precursor calcium hydroxide catalyst at a content of at least about 0.01 wt. % and not greater than about 0.1 wt. % relative to the content of the precursor stucco component. The slurry can also have a pH of at least about 7.5 and not greater than about 10.

In an embodiment, the precursor stucco component may have a particular composition that may facilitate improved performance and/or manufacturing of the gypsum-based construction material. In an embodiment, the gypsum-based slurry composition may comprise calcium sulfate hemihydrate.

In an embodiment, the gypsum-based slurry composition may include a particular content of the precursor stucco component that may facilitate improved performance and/or manufacturing of the gypsum-based construction material. In an embodiment, the gypsum-based slurry composition may comprise the precursor stucco component at a content of at least about 10 wt. % for a total weight of the gypsum-based slurry composition. In an embodiment, the gypsum-based slurry composition may comprise the precursor stucco component at a content of not greater than about 50 wt. % for a total weight of the gypsum-based slurry composition. It will be appreciated that the precursor stucco component content may be between any of the minimum and maximum values noted above.

In an embodiment, the precursor siloxane component may have a particular composition that may facilitate improved performance and/or manufacturing of the gypsum-based construction material. In an embodiment, the precursor siloxane component may comprise polymethylhydrosiloxane (PMHS). PMHS includes both Si—H and Si—CH₃ bonds. The silicone oil of the emulsion as described herein has a hydride content of no more than 0.01 equivalents of Si—H per equivalent of silicon (i.e., silicon atoms). As such, the silicone oil as described herein has a low amount of hydride content, e.g., substantially no hydride content at all. In various embodiments, the silicone oil has a hydride content of no more than 0.005 equivalents, or 0.002 equivalents, or 0.001 equivalents of Si—H per equivalent of silicone.

In an embodiment, the gypsum-based slurry composition may include a particular content of the precursor siloxane component that may facilitate improved performance and/or manufacturing of the gypsum-based construction material. In an embodiment, the gypsum-based slurry composition may comprise the precursor siloxane component at a content of at least about 0.2 wt. % relative to the weight of the precursor stucco component. In an embodiment, the gypsum-based slurry composition may comprise the precursor siloxane component at a content of not greater than about 2.0 wt. % relative to the weight of the precursor stucco component or not greater than about 1.9 wt. % or not greater than 1.8 wt. % or not greater than 1.7 wt. % or not greater than 1.6 wt. % or not greater than 1.5 wt. % or not greater than 1.4 wt. % or not greater than 1.3 wt. % or not greater than 1.2 wt. % or not greater than 1.1 wt. % or not greater than 1.0 wt. % or not greater than 0.9 wt. % or not greater than 0.8 wt. % or not greater than 0.7 wt. % or not greater than 0.6 wt. % relative to the weight of the precursor stucco component. It will be appreciated that the precursor siloxane component content may be between any of the minimum and maximum values noted above.

In an embodiment, the gypsum-based slurry composition may include a particular precursor calcium hydroxide catalyst that may facilitate improved performance and/or manufacturing of the gypsum-based construction material. In an embodiment, the precursor calcium hydroxide catalyst may comprise calcium hydroxide.

In an embodiment, the gypsum-based slurry composition may include a particular content of the precursor calcium hydroxide catalyst that may facilitate improved performance and/or manufacturing of the gypsum-based construction material. In an embodiment, the gypsum-based slurry composition may comprise the precursor calcium hydroxide catalyst at a content of at least about 0.01 wt. % relative to the weight of the precursor stucco component. In an embodiment, the gypsum-based slurry composition may comprise the precursor calcium hydroxide catalyst at a content of not greater than about 0.1 wt. % relative to the weight of the precursor stucco component. It will be appreciated that the precursor calcium hydroxide catalyst content may be between any of the minimum and maximum values noted above.

In an embodiment, the gypsum-based slurry composition may further comprise a precursor reinforcement component. The precursor reinforcement component may comprise a particular material that may facilitate improved performance and/or manufacturing of the gypsum-based construction material. In an embodiment, the precursor reinforcement component can comprise glass fiber.

In an embodiment, the gypsum-based slurry composition may include a particular content of the precursor reinforcement component that may facilitate improved performance and/or manufacturing of the gypsum-based construction material. In an embodiment, the gypsum-based slurry composition may comprise the precursor reinforcement component at a content of at least about 0.03 wt. % relative to the weight of the precursor stucco component. In an embodiment, the gypsum-based slurry composition may comprise the precursor reinforcement component at a content of not greater than about 0.2 wt. % relative to the weight of the precursor stucco component. It will be appreciated that the precursor reinforcement component content may be between any of the minimum and maximum values noted above.

In an embodiment, the gypsum-based slurry composition may further comprise a precursor starch component. The precursor starch component may comprise a particular material that may facilitate improved performance and/or manufacturing of the gypsum-based construction material. In an embodiment, the precursor starch component can comprise an acid modified starch, a chemically modified starch, a natural starch, such as, a corn starch, a sorghum starch, a wheat starch, a tapioca starch, a rice starch, a pea starch, a potato starch, a maize starch, or any combination thereof.

In an embodiment, the gypsum-based slurry composition may include a particular content of the precursor starch component that may facilitate improved performance and/or manufacturing of the gypsum-based construction material. In an embodiment, the gypsum-based slurry composition may comprise the precursor starch component at a content of at least about 0.001 wt. % relative to the weight of the precursor stucco component. In an embodiment, the gypsum-based slurry composition may comprise the precursor starch component at a content of not greater than about 0.7 wt. % relative to the weight of the precursor stucco component. It will be appreciated that the precursor starch component content may be between any of the minimum and maximum values noted above.

In an embodiment, the gypsum-based slurry composition may further comprise a precursor accelerator component. The precursor accelerator component may comprise a particular material that may facilitate improved performance and/or manufacturing of the gypsum-based construction material. In an embodiment, the precursor accelerator component can comprise a heat resistant gypsum accelerator.

In an embodiment, the gypsum-based slurry composition may include a particular content of the precursor accelerator component that may facilitate improved performance and/or manufacturing of the gypsum-based construction material. In an embodiment, the gypsum-based slurry composition may comprise the precursor accelerator component at a content of at least about 0.2 wt. % relative to the weight of the precursor stucco component. In an embodiment, the gypsum-based slurry composition may comprise the precursor accelerator component at a content of not greater than about 5.0 wt. % relative to the weight of the precursor stucco component. It will be appreciated that the precursor accelerator component content may be between any of the minimum and maximum values noted above.

In an embodiment, the gypsum-based slurry composition may further comprise a precursor guar gum component. The precursor guar gum component may comprise a particular material that may facilitate improved performance and/or manufacturing of the gypsum-based construction material. In an embodiment, the precursor guar gum component can comprise a native guar gum, a chemically modified guar gum, or any combination thereof.

In an embodiment, the gypsum-based slurry composition may include a particular content of the precursor guar gum component that may facilitate improved performance and/or manufacturing of the gypsum-based construction material. In an embodiment, the gypsum-based slurry composition may comprise the precursor guar gum component at a content of at least about 0.1 wt. % relative to the weight of the precursor stucco component. In an embodiment, the gypsum-based slurry composition may comprise the precursor guar gum component at a content of not greater than about 1.2 wt. % relative to the weight of the precursor stucco component. It will be appreciated that the precursor guar gum component content may be between any of the minimum and maximum values noted above.

In an embodiment, the gypsum-based slurry composition may further comprise a precursor fluidizing agent component. The precursor fluidizing agent component may comprise a particular material that may facilitate improved performance and/or manufacturing of gypsum-based construction material. In an embodiment, the precursor fluidizing agent component can comprise a polynaphthalene sulfonate, ligno sulfonate, poly carboxylate or any combination thereof.

In an embodiment, the gypsum-based slurry composition may include a particular content of the precursor fluidizing agent component that may facilitate improved performance and/or manufacturing of the gypsum-based construction material. In an embodiment, the gypsum-based slurry composition may comprise the precursor fluidizing agent component at a content of at least about 0.1 wt. % relative to the weight of the precursor stucco component. In an embodiment, the gypsum-based slurry composition may comprise the precursor fluidizing agent component at a content of not greater than about 1 wt. % relative to the weight of the precursor stucco component. It will be appreciated that the precursor fluidizing agent component content may be between any of the minimum and maximum values noted above.

In an embodiment, the gypsum-based slurry composition may comprise a particular pH that may facilitate improved performance and/or manufacturing of the gypsum-based construction material. In an embodiment, the pH may be at least 7.6. In an embodiment, the pH may be less than 9.9. It will be appreciated that the pH may be between any of the minimum and maximum values noted above.

In an embodiment, the gypsum-based slurry composition may further comprise water.

In an embodiment, the gypsum-based slurry composition may further comprise a precursor retardant component.

In an embodiment, the gypsum-based slurry composition may further comprise water precursor foam component.

In an embodiment, the aforementioned gypsum-based slurry composition may be deposited to form a gypsum preform of a gypsum-based construction material preform. The gypsum preform can then be fired to make a gypsum core. In an embodiment, the gypsum core may comprise a stucco component, a siloxane component at content of not greater than about 2.0 wt. % relative to a content of the stucco component, and a calcium hydroxide catalyst at a content of at least about 0.01 wt. % and not greater than about 0.1 wt. % relative to the content of the precursor stucco component. The slurry can also have a pH of at least about 7.5 and not greater than about 10.

In an embodiment, the aforementioned gypsum-based slurry composition may be casted to form a gypsum-based construction material such as, a panel, a board, walls, plinths, slabs, columns, sheets, casts or shafts.

In an embodiment, the gypsum core may include a particular content of the stucco component that may facilitate improved performance and/or manufacturing of the gypsum core. In an embodiment, the gypsum core may comprise the stucco component at a content of at least about 60 wt. % for a total weight of the gypsum core. In an embodiment, the gypsum-based slurry composition may comprise the stucco component at a content of not greater than about 85 wt. % for a total weight of the gypsum-core. It will be appreciated that the stucco component content may be between any of the minimum and maximum values noted above.

In an embodiment, the siloxane component may have a particular composition that may facilitate improved performance and/or manufacturing of the gypsum core. In an embodiment, the siloxane component may comprise PMHS. PMHS includes both Si—H and Si—CH₃ bonds. The silicone oil of the emulsion as described herein has a hydride content of no more than 0.01 equivalents of Si—H per equivalent of silicon (i.e., silicon atoms). As such, the silicone oil as described herein has a low amount of hydride content, e.g., substantially no hydride content at all. In various embodiments, the silicone oil has a hydride content of no more than 0.005 equivalents, or 0.002 equivalents, or 0.001 equivalents of Si—H per equivalent of silicone.

In an embodiment, the gypsum core may include a particular content of the siloxane component that may facilitate improved performance and/or manufacturing of the gypsum core. In an embodiment, the gypsum-based slurry composition may comprise the siloxane component at a content of at least about 0.1 wt. % relative to the weight of the precursor stucco component. In an embodiment, the gypsum-based slurry composition may comprise the siloxane component at a content of or not greater than about 1.9 wt. % or not greater than 1.8 wt. % or not greater than 1.7 wt. % or not greater than 1.6 wt. % or not greater than 1.5 wt. % or not greater than 1.4 wt. % or not greater than 1.3 wt. % or not greater than 1.2 wt. % or not greater than 1.1 wt. % or not greater than 1.0 wt. % or not greater than 0.9 wt. % or not greater than 0.8 wt. % or not greater than 0.7 wt. % or not greater than 0.6 wt. % relative to the weight of the precursor stucco component. It will be appreciated that the siloxane component content may be between any of the minimum and maximum values noted above.

In an embodiment, the gypsum core may include a particular calcium hydroxide catalyst that may facilitate improved performance and/or manufacturing of the gypsum-based construction material. In an embodiment, the calcium hydroxide catalyst may comprise calcium hydroxide.

In an embodiment, the gypsum core may include a particular content of the calcium hydroxide catalyst that may facilitate improved performance and/or manufacturing of the gypsum-based construction material. In an embodiment, the gypsum core may comprise the calcium hydroxide catalyst at a content of at least about 0.01 wt. % or at least about 0.02 wt. % relative to the weight of the precursor stucco component. In an embodiment, the gypsum core may comprise the precursor calcium hydroxide catalyst at a content of not greater than about 0.1 wt. % relative to the weight of the precursor stucco component. It will be appreciated that the calcium hydroxide catalyst content may be between any of the minimum and maximum values noted above.

In an embodiment, the gypsum core may further comprise a precursor guar gum component. The precursor guar gum component may comprise a particular material that may facilitate improved performance and/or manufacturing of the gypsum-based construction material. In an embodiment, the precursor guar gum component can comprise a native guar gum, a chemically modified guar gum, or any combination thereof.

In an embodiment, the gypsum-based construction material may comprise a particular water absorption improvement percentage that may facilitate improved performance and/or manufacturing of the gypsum-based construction material. The water absorption improvement percentage can be measured according to ASTM C473. In an embodiment the water absorption improvement percentage can be at least about 5% relative to the ASTM C473 standard material. In an embodiment the gypsum-based construction material can be rated for 2 hours total water absorption per ASTM C473 Method B.

In an embodiment, the gypsum-based construction material may comprise a particular thickness that may facilitate improved performance and/or manufacturing of the gypsum-based construction material. In an embodiment, the thickness may be at least 5.0 mm. In an embodiment, the thickness may be less than 30 mm. It will be appreciated that the thickness may be between any of the minimum and maximum values noted above.

In an embodiment, the gypsum-based construction material may comprise a particular density that may facilitate improved performance and/or manufacturing of the gypsum-based construction material. In an embodiment, the density may be at least 1250 lbs./msf. In an embodiment, the density may be less than 2550 lbs./msf. It will be appreciated that the density may be between any of the minimum and maximum values noted above.

In an embodiment, the gypsum-based construction material may comprise a particular pH that may facilitate improved performance and/or manufacturing of the gypsum-based construction material. In an embodiment, the pH may be at least 7.6 or at least 7.7 or at least 7.8 or at least 7.9 or at least 8.0. In an embodiment, the pH may be less than 9.9. It will be appreciated that the pH may be between any of the minimum and maximum values noted above.

In an embodiment, the gypsum-based construction material can further include at least one liner. The liner may be a particular material that may facilitate improved performance and/or manufacturing of the gypsum-based construction material. In an embodiment, the liner may comprise a paper liner, a glass mat liner, or any combination thereof.

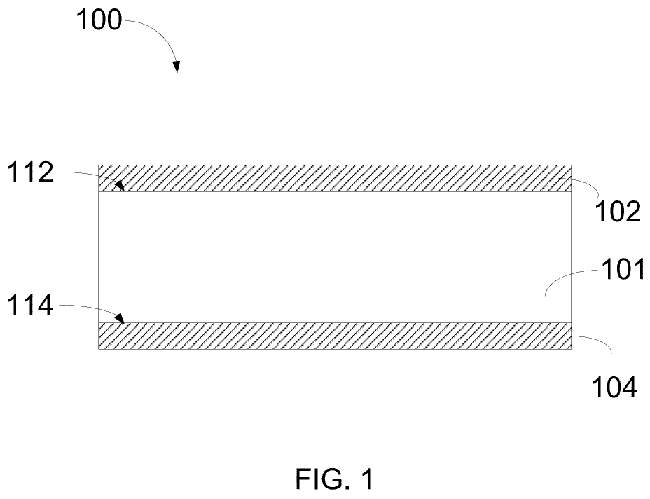

In an embodiment, the at least one liner can be present on a major surface of the gypsum-based construction material. In another embodiment, the gypsum-based construction material can include two liners present on opposing major surfaces. An example of such a gypsum board is shown in a cross-sectional schematic view in FIG. 1. Here, gypsum-based construction material (100) including a gypsum core (101) and a first liner (102) at a first major surface (112) of the gypsum core; a second liner (104) at a second, opposing major surface (114) of the gypsum core.

In an embodiment, the gypsum-based construction material can exhibit moisture resistance.

### Embodiments

Embodiment 1. A gypsum-based slurry composition comprising:
a precursor stucco component,
a precursor siloxane component at a content of not greater than about 2.0 wt. % relative to a content of the precursor stucco component, and
a precursor calcium hydroxide catalyst at a content of at least about 0.01 wt. % and not greater than about 0.1 wt. % relative to the content of the precursor stucco component,
wherein the gypsum-based slurry composition has a pH of at least about 7.5 and not greater than about 10.

Embodiment 2. A gypsum-based construction material comprising a gypsum core, wherein the gypsum core comprises:
a stucco component,
a siloxane component at a content of not greater than about 2.0 wt. % relative to a content of the stucco component, and
a calcium hydroxide catalyst at a content of at least about 0.01 wt. % and not greater than about 0.1 wt. % relative to the content of the stucco component,
wherein the gypsum-based construction material has a pH of at least about 7.5 and not greater than about 10.

Embodiment 3. A method of forming a gypsum-based construction material, wherein the method comprises
providing a gypsum-based slurry composition comprising:
a precursor stucco component,
a precursor siloxane component at a content of not greater than about 2.0 wt. % relative to a content of the precursor stucco component, and
a precursor calcium hydroxide catalyst at a content of at least about 0.01 wt. % and not greater than about 0.1 wt. % relative to the content of the precursor stucco component,
wherein the gypsum-based slurry composition has a pH of at least about 7.5 and not greater than about 10,
depositing the slurry composition to form a gypsum preform of the gypsum-based construction material preform, and
firing the gypsum prefrom of the gypsum-based construction material to form a gypsum core.

Embodiment 4. The gypsum-based slurry composition or method of any one of embodiments 1 and 3, wherein the precursor stucco component comprises calcium sulfate hemihydrate.

Embodiment 5. The gypsum-based slurry composition or method of any one of embodiments 1 and 3, wherein the gypsum-based slurry composition comprises the precursor stucco component at a content of at least about 10 wt. % for a total weight of the gypsum-based slurry composition.

Embodiment 6. The gypsum-based slurry composition or method of any one of embodiments 1 and 3, wherein the gypsum-based slurry composition comprises the stucco component at a content of not greater than about 50 wt. % for a total weight of the gypsum-based slurry composition.

Embodiment 7. The gypsum-based slurry composition or method of any one of embodiments 1 and 3, wherein the precursor siloxane component comprises polymethylhydrosiloxane (PMHS).

Embodiment 8. The gypsum-based slurry composition or method of any one of embodiments 1 and 3, wherein the gypsum-based slurry composition comprises the precursor siloxane component at a content of at least about 0.2 wt. % relative to the content of the precursor stucco component.

Embodiment 9. The gypsum-based slurry composition or method of any one of embodiments 1 and 3, wherein the gypsum-based slurry composition comprises the precursor siloxane component at a content of not greater than about 2.0 wt. % or not greater than about 1.9 wt. % or not greater than 1.8 wt. % or not greater than 1.7 wt. % or not greater than 1.6 wt. % or not greater than 1.5 wt. % or not greater than 1.4 wt. % or not greater than 1.3 wt. % or not greater than 1.2 wt. % or not greater than 1.1 wt. % or not greater than 1.0 wt. % or not greater than 0.9 wt. % or not greater than 0.8 wt. % or not greater than 0.7 wt. % or not greater than 0.6 wt. % relative to the weight of the precursor stucco component.

Embodiment 10. The gypsum-based slurry composition or method of any one of embodiments 1 and 3, wherein the precursor calcium hydroxide catalyst comprises calcium hydroxide.

Embodiment 11. The gypsum-based slurry composition or method of any one of embodiments 1 and 3, wherein the gypsum-based slurry composition comprises the precursor calcium hydroxide catalyst at a content of at least about 0.01 wt. % relative to the content of the precursor stucco component.

Embodiment 12. The gypsum-based slurry composition or method of any one of embodiments 1 and 3, wherein the gypsum-based slurry composition comprises the precursor calcium hydroxide catalyst at a content of not greater than about 0.1 wt. % relative to the content of the precursor stucco component.

Embodiment 13. The gypsum-based slurry composition or method of any one of embodiments 1 and 3, wherein the gypsum-based slurry further comprises a precursor reinforcement component.

Embodiment 14. The gypsum-based slurry composition or method of embodiment 13, wherein the precursor reinforcement component comprises of glass fiber.

Embodiment 15. The gypsum-based slurry composition or method of embodiment 13, wherein the gypsum-based slurry composition comprises the precursor reinforcement component at a content of at least about 0.03 wt. % relative to the content of the precursor stucco component.

Embodiment 16. The gypsum-based slurry composition or method of embodiment 13, wherein the gypsum-based slurry composition comprises the precursor reinforcement component at a content of not greater than about 0.2 wt. % relative to the content of the precursor stucco component.

Embodiment 17. The gypsum-based slurry composition or method of any one of embodiments 1 and 3, wherein the gypsum-based slurry further comprises a precursor starch component.

Embodiment 18. The gypsum-based slurry composition or method of embodiment 17, wherein the precursor starch component comprises an acid modified starch, a chemically modified starch, a natural starch, such as, a corn starch, a sorghum starch, a wheat starch, a tapioca starch, a rice starch, a pea starch, a potato starch, a maize starch, or any combination thereof.

Embodiment 19. The gypsum-based slurry composition or method of embodiment 17, wherein the gypsum-based slurry composition comprises the precursor starch component at a content of at least about 0.001 wt. % relative to the content of the precursor stucco component.

Embodiment 20. The gypsum-based slurry composition or method of embodiment 17, wherein the gypsum-based slurry composition comprises the precursor starch component at a content of not greater than about 0.7 wt. % relative to the content of the precursor stucco component.

Embodiment 21. The gypsum-based slurry composition or method of any one of embodiments 1 and 3, wherein the gypsum-based slurry further comprises a precursor accelerator component.

Embodiment 22. The gypsum-based slurry composition or method of embodiment 21, wherein the precursor accelerator component comprises a heat resistant gypsum accelerator.

Embodiment 23. The gypsum-based slurry composition or method of embodiment 21, wherein the gypsum-based slurry composition comprises the precursor accelerator component at a content of at least about 0.2 wt. % relative to the content of the precursor stucco component.

Embodiment 24. The gypsum-based slurry composition or method of embodiment 21, wherein the gypsum-based slurry composition comprises the precursor accelerator component at a content of not greater than about 5.0 wt. % relative to the content of the precursor stucco component.

Embodiment 25. The gypsum-based slurry composition or method of any one of embodiments 1 and 3, wherein the gypsum-based slurry further comprises a precursor guar gum component.

Embodiment 26. The gypsum-based slurry composition or method of embodiment 25, wherein the precursor guar gum component comprises a native guar gum, a chemically modified guar gum, or any combination thereof.

Embodiment 27. The gypsum-based slurry composition or method of embodiment 25, wherein the gypsum-based slurry composition comprises the precursor guar gum component at a content of at least about 0.1 wt. % relative to the content of the precursor stucco component.

Embodiment 28. The gypsum-based slurry composition or method of embodiment 25, wherein the gypsum-based slurry composition comprises the precursor guar gum component at a content of not greater than about 1.2 wt. % relative to the content of the precursor stucco component.

Embodiment 29. The gypsum-based slurry composition or method of any one of embodiments 1 and 3, wherein the gypsum-based slurry further comprises a fluidizing agent.

Embodiment 30. The gypsum-based slurry composition or method of embodiment 29, wherein the precursor fluidizing agent component comprises polynaphthalene sulfonate, ligno sulfonate, poly carboxylate or any combination thereof.

Embodiment 31. The gypsum-based slurry composition or method of embodiment 29, wherein the gypsum-based slurry composition comprises the precursor fluidizing agent component at a content of at least about 0.1 wt. % relative to the content of the precursor stucco component.

Embodiment 32. The gypsum-based slurry composition or method of embodiment 29, wherein the gypsum-based slurry composition comprises the precursor fluidizing agent component at a content of not greater than about 1 wt. % relative to the content of the precursor stucco component.

Embodiment 33. The gypsum-based slurry composition or method of any one of embodiments 1 and 3, wherein the gypsum-based slurry further comprises water.

Embodiment 34. The gypsum-based slurry composition or method of any one of embodiments 1 and 3, wherein the gypsum-based slurry further comprises a precursor retardant component.

Embodiment 35. The gypsum-based slurry composition or method of any one of embodiments 1 and 3, wherein the gypsum-based slurry further comprises a precursor foam component.

Embodiment 36. The gypsum-based slurry composition or method of any one of embodiments 1 and 3, wherein the foaming agent is selected from the group consisting of alkyl ether sulfate, ethoxylated surfactant or lauryl surfactants.

Embodiment 37. The gypsum-based slurry composition or method of embodiment 36, wherein the foaming agent is selected from the group consisting of alkyl ether sulfate, ethoxylated surfactant or lauryl surfactants.

Embodiment 38. The method of embodiment 3, wherein the gypsum core comprises a stucco component, a siloxane component, and a calcium hydroxide catalyst.

Embodiment 39. The gypsum-based construction material or method of any one of embodiments 2 and 38, wherein the gypsum core comprises the stucco component at a content of at least about 60 wt. % for a total weight of the gypsum core.

Embodiment 40. The gypsum-based construction material or method of any one of embodiments 2 and 38, wherein the gypsum core comprises the stucco component at a content of not greater than about 85 wt. % for a total weight of the gypsum core.

Embodiment 41. The gypsum-based construction material or method of any one of embodiments 2 and 38, wherein the siloxane component comprises polymethylhydrosiloxane (PMHS).

Embodiment 42. The gypsum-based construction material or method of any one of embodiments 2 and 38, wherein the gypsum core comprises the siloxane component at a content of at least about 0.1 wt. % for a total weight of the gypsum core.

Embodiment 43. The gypsum-based construction material or method of any one of embodiments 2 and 38, wherein the gypsum core comprises the siloxane component at a content of not greater than about 2.0 wt. % or not greater than about 1.9 wt. % or not greater than 1.8 wt. % or not greater than 1.7 wt. % or not greater than 1.6 wt. % or not greater than 1.5 wt. % or not greater than 1.4 wt. % or not greater than 1.3 wt. % or not greater than 1.2 wt. % or not greater than 1.1 wt. % or not greater than 1.0 wt. % or not greater than 0.9 wt. % or not greater than 0.8 wt. % or not greater than 0.7 wt. % or not greater than 0.6 wt for a total weight of the gypsum core.

Embodiment 44. The gypsum-based construction material or method of any one of embodiments 2 and 38, wherein the calcium hydroxide catalyst comprises calcium hydroxide.

Embodiment 45. The gypsum-based construction material or method of any one of embodiments 2 and 38, wherein the gypsum core comprises the calcium hydroxide catalyst at a content of at least about 0.02 wt. % for a total weight of the gypsum core.

Embodiment 46. The gypsum-based construction material or method of any one of embodiments 2 and 38, wherein the gypsum core comprises the calcium hydroxide catalyst at a content of not greater than about 0.1 wt. % for a total weight of the gypsum core.

Embodiment 47. The gypsum-based construction material or method of any one of embodiments 2 and 38, wherein the gypsum core further comprises a guar gum component.

Embodiment 48. The gypsum-based construction material or method of embodiment 47, wherein the guar gum component comprises a native guar gum, a chemically modified guar gum, or any combination thereof.

Embodiment 49. The gypsum-based slurry composition, gypsum-based construction material or method of any one of embodiments 1, 2, and 3, wherein the gypsum-based slurry composition comprises an ASTM C473 water absorption improvement percentage of at least about 5% relative to the ASTM C473 standard material.

Embodiment 50. The gypsum-based construction material or method of any one of embodiments 2 and 3, wherein the construction material is rated for 2 hours total water absorption per ASTM C473 Method B.

Embodiment 51. The gypsum-based slurry composition, gypsum-based construction material or method of any one of embodiments 1, 2, and 3, wherein the construction material has a thickness of at least 5.0 mm.

Embodiment 52. The gypsum-based slurry composition, gypsum-based construction material or method of any one of embodiments 1, 2, and 3, wherein the construction material has a thickness of less than 30 mm.

Embodiment 53. The gypsum-based slurry composition, gypsum-based construction material or method of any one of embodiments 1, 2, and 3, wherein the construction material has a density of at least 1250 lbs./msf.

Embodiment 54. The gypsum-based slurry composition, gypsum-based construction material or method of any one of embodiments 1, 2, and 3, wherein the construction material has a density of less than 2550 lbs./msf.

Embodiment 55. The gypsum-based slurry composition, gypsum-based construction material or method of any one of embodiments 1, 2, and 3, wherein the gypsum-based slurry composition comprises a pH of at least about 7.6 or at least 7.7 or at least 7.8 or at least 7.9 or at least 8.0.

Embodiment 56. The gypsum-based slurry composition, gypsum-based construction material or method of any one of embodiments 1, 2, and 3, wherein the gypsum-based slurry composition comprises a pH of not greater than about 9.9.

Embodiment 57. The gypsum-based construction material or method of any one of embodiments 2 and 3, wherein the gypsum-based construction material comprises a pH of at least about 7.6.

Embodiment 58. The gypsum-based construction material or method of any one of embodiments 2 and 3, wherein the gypsum-based construction material comprises a pH of not greater than about 9.9.

Embodiment 59. The gypsum-based slurry composition of embodiment 1, wherein the gypsum-based slurry is casted to form a gypsum-based construction material, such as, a panel, a board, walls, plinths, slabs, columns, sheets, casts or shafts.

Embodiment 60. The gypsum-based construction material or method of any one of embodiments 2, 3, or 59, wherein the gypsum-based construction material further comprises at least one liner.

Embodiment 61. The gypsum-based construction material or method of embodiment 60, wherein the at least one liner comprises a paper liner, a glass mat liner, or any combination thereof.

Embodiment 62. The gypsum-based construction material or method of any one of embodiments 2, 3, or 59, wherein the gypsum-based construction material exhibits moisture resistance.

### Examples

The following non-limiting examples illustrate the present invention.

Samples S1 and S2 and comparative sample CS1 were prepared according to the process below and the compositions in table 1. To prepare the boards, stucco was mixed with water (75-85 wt. % based on the weight of the stucco), PMHS (0.2-2 wt. % based on the weight of the stucco), Ca(OH)₂ (amounts outlined in table 1), glass fiber (0.03-0.4 wt. %), starch (0.001-0.7 wt. % based on the weight of the stucco), a gypsum accelerator (0.2-0.55 wt. % based on the weight of the stucco, a fluidizer (0.05-1 wt. % based on the weight of the stucco), a foaming agent, and a retardant.

Gypsum cores were then formed by allowing the gypsum slurry to set and then dry. Each board was ⅝ inches thick. The samples were made and tested by ASTM C473 (Water Resistance of Core-Treated Water-Repellent Gypsum Panel Products).

TABLE 1

| | Concentration of | | Board | | ASTM |
|---|---|---|---|---|---|
| | Ca(OH)₂ | | weight | | water |
| Board | wt. % to | lbs./ | lbs./ | | absorption |
| No. | stucco | msf | msf | pH | % |
| CS1 | 0% | 0 | 2170 | 6.96 | 5.01% |
| S1 | 0.028 | 0.5 | 2170 | 8.05 | 4.81% |
| S2 | 0.032 | 0.7 | 2170 | 8.58 | 4.64% |

Samples S3-S5 and CS3-CS5 were prepared according to the same process as S51, S2, and CS1 noted above based on the weight of stucco and variable amounts of PMHS according to table 2 below. Samples S3-S5 contained approximately 0.02-0.04 wt. % Ca(OH)₂, while comparative samples had no Ca(OH)₂.

TABLE 2

| | Concentration of PMHS | | | ASTM water |
|---|---|---|---|---|
| Board | wt. % to | lbs./ | | absorption |
| No. | stucco | msf | Ca(OH)₂ | % |
| CS3 | 0.58% | 12 | No | 6.1% |
| CS4 | 0.63% | 13 | No | 5.5% |
| CS5 | 0.68% | 14 | No | 5.2% |
| S3 | 0.58% | 12 | Yes | 5.1% |
| S4 | 0.63% | 13 | Yes | 5.0% |
| S5 | 0.68% | 14 | Yes | 4.9% |

Notably, the samples with Ca(OH)₂ were capable of producing boards with significantly reduced water absorption, even with small amounts of PMHS, whereas the comparative samples needed significantly more PMHS in order to achieve comparable water absorption.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of the invention.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

What is claimed is:

1. A gypsum-based slurry composition comprising:
a precursor stucco component,
a precursor siloxane component at a content of not greater than about 2.0 wt. % relative to a content of the precursor stucco component, and
a precursor calcium hydroxide catalyst at a content of at least about 0.01 wt. % and not greater than about 0.1 wt. % relative to the content of the precursor stucco component,
wherein the gypsum-based slurry composition has a pH of at least about 7.5 and not greater than about 10.

2. The gypsum-based slurry composition of claim 1, wherein the precursor siloxane component comprises polymethylhydrosiloxane (PMHS).

3. The gypsum-based slurry composition of claim 1, wherein the gypsum-based slurry composition comprises the precursor siloxane component at a content of at least about 0.2 wt. % and not greater than about 2.0 wt. % relative to the content of the precursor stucco component.

4. The gypsum-based slurry composition of claim 1, wherein the precursor calcium hydroxide catalyst comprises calcium hydroxide.

5. The gypsum-based slurry composition of claim 1, wherein the gypsum-based slurry composition comprises the precursor calcium hydroxide catalyst at a content of at least about 0.01 wt. % and not greater than about 0.1 wt. % relative to the content of the precursor stucco component.

6. The gypsum-based slurry composition of claim 1, wherein the gypsum-based slurry composition comprises an ASTM C473 water absorption improvement percentage of at least about 5% relative to the ASTM C473 standard material.

7. The gypsum-based slurry composition of claim 1, wherein the gypsum-based slurry composition comprises a pH of at least about 7.6 and not greater than about 9.9.

8. A gypsum-based construction material comprising a gypsum core, wherein the gypsum core comprises:
a stucco component,
a siloxane component at a content of not greater than about 2.0 wt. % relative to a content of the stucco component, and
a calcium hydroxide catalyst at a content of at least about 0.01 wt. % and not greater than about 0.1 wt. % relative to the content of the stucco component,
wherein the gypsum-based construction material has a pH of at least about 7.5 and not greater than about 10.

9. The gypsum-based construction material of claim 8, wherein the siloxane component comprises polymethylhydrosiloxane (PMHS).

10. The gypsum-based construction material of claim 8, wherein the gypsum-based construction material composition comprises the siloxane component at a content of at least about 0.2 wt. % and not greater than about 2.0 wt. % relative to the content of the stucco component.

11. The gypsum-based construction material of claim 8, wherein the calcium hydroxide catalyst comprises calcium hydroxide.

12. The gypsum-based construction material of claim 8, wherein the gypsum-based construction material composition comprises the calcium hydroxide catalyst at a content of at least about 0.01 wt. % and not greater than about 0.1 wt. % relative to the content of the stucco component.

13. The gypsum-based construction material of claim 8, wherein the gypsum-based slurry composition comprises an ASTM C473 water absorption improvement percentage of at least about 5% relative to the ASTM C473 standard material.

14. The gypsum-based construction material of claim 8, wherein the gypsum-based slurry composition comprises a pH of at least about 7.6 and not greater than about 9.9.

15. The gypsum-based construction material of claim 8, wherein the construction material is rated for 2 hours total water absorption per ASTM C473 Method B.

16. A method of forming a gypsum-based construction material, wherein the method comprises
providing a gypsum-based slurry composition comprising:
a precursor stucco component,
a precursor siloxane component at a content of not greater than about 2.0 wt. % relative to a content of the precursor stucco component, and
a precursor calcium hydroxide catalyst at a content of at least about 0.01 wt. % and not greater than about 0.1 wt. % relative to the content of the precursor stucco component,
wherein the gypsum-based slurry composition has a pH of at least about 7.5 and not greater than about 10,
depositing the slurry composition to form a gypsum preform of the gypsum-based construction material preform, and
firing the gypsum preform of the gypsum-based construction material to form a gypsum core.

17. The method of claim 16, wherein the precursor siloxane component comprises polymethylhydrosiloxane (PMHS).

18. The method of claim 16, wherein the gypsum-based slurry composition comprises the precursor siloxane component at a content of at least about 0.2 wt. % and not greater than about 2.0 wt. % relative to the content of the precursor stucco component.

19. The method of claim 16, wherein the precursor calcium hydroxide catalyst comprises calcium hydroxide.

20. The method of claim 16, wherein the gypsum-based slurry composition comprises the precursor calcium hydroxide catalyst at a content of at least about 0.01 wt. % and not greater than about 0.1 wt. % relative to the content of the precursor stucco component.
